(19) United States
(12) Patent Application Publication
(10) Pub. No.: US 2020/0317960 A1
(43) Pub. Date: Oct. 8, 2020

(54) TRANSPARENT ADHESIVE FILM

(71) Applicant: NITTO DENKO CORPORATION, Ibaraki-shi, Osaka (JP)

(72) Inventors: Kensuke TANI, Ibaraki-shi, Osaka (JP); Yoshiko KIRA, Ibaraki-shi, Osaka (JP); Mizuho KIYOHARA, Ibaraki-shi, Osaka (JP); Shinya HIRAOKA, Ibaraki-shi, Osaka (JP)

(21) Appl. No.: 16/652,183

(22) PCT Filed: Sep. 27, 2018
(86) PCT No.: PCT/JP2018/036037

§ 371 Date: Mar. 30, 2020

(30) Foreign Application Priority Data
Sep. 29, 2017 (JP) 2017-191818
Sep. 27, 2018 (JP) 2018-181115

(51) Int. Cl. C09J 7/29; C09J 121/00; C09J 133/08; C09J 7/40

(52) U.S. Cl. CPC C09J 7/29; C09J 7/403; C09J 133/08; C09J 121/00

(57) ABSTRACT

An object of the present invention is to provide a transparent adhesive film which is hardly visually recognized, that is, inconspicuous, and thereby has little influence on design properties of an adherend. The present invention relates to a transparent adhesive film including: a base material having an uneven surface; and an adhesive layer laminated on a surface of the base material on a side opposite to the uneven surface, in which a mean spacing Sm of an unevenness on the uneven surface of the base material is 45 μm or more, an average tilt angle θa of the unevenness on the uneven surface of the base material is 0.5° to 15°, and a 60-degree glossiness GL on the uneven surface of the base material is 60% or less.

### CROSS REFERENCE TO RELATED APPLICATION

The present application is a national stage filing under 35 U.S.C § 371 of PCT application number PCT/JP2018/036037 filed on Sep. 27, 2018, which designates the United States and was published in Japan, and which claims priority to Japanese Patent Application Nos. 2017-191818 filed on Sep. 29, 2017 and 2018-181115 filed on Sep. 27, 2018, in the Japanese Patent Office. The disclosures of the above-listed applications are hereby incorporated by reference herein in their entireties.

### TECHNICAL FIELD

The present invention relates to a transparent adhesive film.

### BACKGROUND ART

There is a known technique for attaching an adhesive sheet to a surface of various products for various purposes such as prevention of damage (scratches, stains, and the like), anti-slip, and anti-glare in products. Such an adhesive sheet generally includes a base material and an adhesive layer, and is bonded to an adherend via the adhesive layer.

For example, Patent Literature 1 discloses a decorative sheet which includes a surface protective layer on an outermost surface, and is characterized as follows: (1) the surface protective layer has an unevenness, and a mean spacing Sm between the unevenness is 180 μm to 400 μm; (2) a maximum height Rz of the surface protective layer is 20 to 50 μm; and (3) a coefficient of static friction of the surface protective layer is 0.37 or more.

In addition, Patent Literature 2 discloses a decorative sheet for flooring materials which includes at least a transparent resin layer having a thickness of 150 μm or more and laminated on a base material sheet via an adhesive layer, and which is characterized as follows: (1) the transparent resin layer is composed of two or more polypropylene resin layers; and (2) among the two or more polypropylene resin layers, a polypropylene resin layer bonded to the base material sheet has a bending stiffness of 200 to 500 MPa.

Furthermore, Patent Literature 3 discloses a transparent anti-skid protective sheet which includes a support layer having a first main surface and a second main surface on a side opposite to the first main surface, and in which a plurality of hemispherical protrusions are disposed on the first main surface, and the hemispherical protrusions are surrounded by a land part constituting a part of the first main surface.

### CITATION LIST

### Patent Literature

Patent Literature 1: JP-A-2011-93298
Patent Literature 2: JP-A-2011-69060
Patent Literature 3: JP-A-2010-19028

### SUMMARY OF INVENTION

### Technical Problem

Patent Literature 1 and Patent Literature 2 disclose decorative sheets generally used by being attached to various building materials such as flooring materials, furniture, and the like, and it is necessary that the decorative sheets do not impair design properties of an adherend in such use applications. Decorative sheets themselves basically have colors and patterns, and are suitable in a case of being attached to a product having a design property of favorable compatibility with their colors and patterns, whereas in a case of being attached to products other than that, design properties of the products themselves may be impaired.

Furthermore, Patent Literature 3 discloses a protective sheet to be installed on a road surface or a floor, and it is necessary that the protective sheet does not impair design properties of an adherend even in such use applications. The protective sheet disclosed in Patent Literature 3 is transparent, but even transparent sheets may result in a case in which design properties of an adherend are impaired because light is reflected depending on angles, light is scattered and a sheet appears white, and the like. However, Patent Literature 3 does not focus on visibility of the sheet, and therefore it is unclear whether or not the protective sheet disclosed in Patent Literature 3 impairs design properties of an adherend.

In view of the above descriptions, an object of the present invention is to provide a transparent adhesive film which is hardly visually recognized, that is, inconspicuous, and thereby has little influence on design properties of an adherend.

### Solution to Problem

The inventors of the present invention have conducted intensive studies in view of the above-described problems, and as a result, they have found that the above-described problems can be solved by a transparent adhesive film having the following structure, and therefore have completed the present invention.

That is, a transparent adhesive film of the present invention includes: a base material having an uneven surface; and an adhesive layer laminated on a surface of the base material on a side opposite to the uneven surface, wherein a mean spacing Sm of an unevenness on the uneven surface of the base material is 45 μm or more, wherein an average tilt angle θa of the unevenness on the uneven surface of the base material is 0.5° to 15°, and wherein a 60-degree glossiness GL on the uneven surface of the base material is 60% or less.

Furthermore, the transparent adhesive film according to one aspect of the present invention may have two or more laminate units each including the base material and the adhesive layer.

Furthermore, the transparent adhesive film according to one aspect of the present invention may further include a release treatment layer formed on the uneven surface of the base material.

Furthermore, in the transparent adhesive film according to one aspect of the present invention, the adhesive layer positioned on an outermost side of the transparent adhesive film may have a storage elastic modulus of 1×10⁶ Pa or less at 23° C., the storage elastic modulus being measured by dynamic viscoelasticity measurement under a condition of a shear strain at a frequency of 1 Hz.

Furthermore, in the transparent adhesive film according to one aspect of the present invention, the adhesive layer may contain at least one selected from the group consisting of an acrylic adhesive and a rubber adhesive.

### Advantageous Effects of Invention

A transparent adhesive film of the present invention is hardly visually recognized, and thus is inconspicuous. Accordingly, the transparent adhesive film has little influence on design properties of an adherend.

### BRIEF DESCRIPTION OF DRAWINGS

FIG. 1 is a schematic cross-sectional view of a transparent adhesive film according to a first embodiment of the present invention.

FIG. 2 is a schematic cross-sectional view of one aspect of a transparent adhesive film according to a second embodiment of the present invention.

FIG. 3 is a schematic cross-sectional view of another aspect of the transparent adhesive film according to the second embodiment of the present invention.

### DESCRIPTION OF EMBODIMENTS

Hereinafter, embodiments for carrying out the present invention will be described in detail. Note that the present invention is not limited to the embodiments to be described below.

In addition, in the present specification, the definition of a mean spacing Sm, an average tilt angle θa, and an arithmetic average surface roughness Ra of the unevenness of an uneven surface are based on JIS B 0601 (1994 version). Furthermore, these characteristic values can be measured by a stylus type surface roughness measuring instrument (for example, a high-precision fine-shape-measuring instrument manufactured by Kosaka Laboratories, trade name “SURFCORDER ET4000”). An average tilt angle θa is a value defined by the equation θa=tan⁻¹Δa. Δa is a value obtained by dividing the sum (h1+h2+h3+ . . . +hn), the sum of differences (a height h) between an apex of an adjacent projection part and the lowest point of a recessed part in a roughness curve specified in JIS B 0601 (1994 version) by a reference length L of a roughness curve, that is, a value represented by the equation Δa=(h1+h2+h3+ . . . +hn)/L.

Furthermore, in the present specification, the definition of a 60-degree glossiness GL is based on JIS Z 8741 (1997 version).

In the present specification, the term “film” includes a sheet, and the term “sheet” includes a film.

A transparent adhesive film (hereinafter, also simply referred to as a “adhesive film”) of the present invention includes: a base material having an uneven surface; and an adhesive layer laminated on a surface of the base material on a side opposite to the uneven surface, in which a mean spacing Sm of an unevenness on the uneven surface of the base material is 45 μm or more, an average tilt angle θa of the unevenness on the uneven surface of the base material is 0.5° to 15°, and a 60-degree glossiness GL on the uneven surface of the base material is 60% or less.

The term “transparent” refers to a case in which a transmittance of light having a wavelength of 380 nm to 780 nm is 40% or more.

The adhesive film of the present invention is used by being attached to an adherend via the adhesive layer. Hereinafter, a surface of the adhesive film on a side that is attached to an adherend may be referred to as an “adhesive surface.” The adherend refers to an object to which the adhesive film is attached and is not particularly limited, and examples thereof include flooring, furniture, automobiles, machines, robots, skin, and the like.

The adhesive film of the present invention may include a base material and an adhesive layer as in a first embodiment described below, and or may include a plurality of laminate units each having a base material and an adhesive layer as in a second embodiment to be described below. Hereinafter, the first and second embodiments of the present invention will be described. The present invention is not limited to these embodiments.

### First Embodiment

<Transparent Adhesive Film>

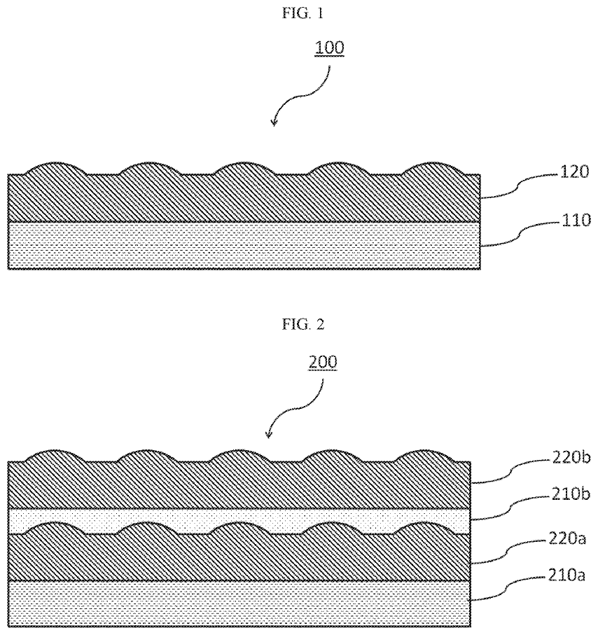

FIG. 1 is an example of a schematic cross-sectional view of a transparent adhesive film according to the first embodiment of the present invention.

An adhesive film 100 of the present embodiment includes a base material 120 and an adhesive layer 110.

Until the adhesive film 100 of the present embodiment is attached to an adherend, it is preferable that a release film be provided on a surface of the adhesive surface, or the adhesive surface be protected by a method in which a surface of the base material 120 on a side opposite to the adhesive layer 110 comes into contact with the adhesive surface layer 110 by winding the adhesive film 100 in a roll shape.

A thickness of the adhesive film 100 of the present embodiment is not particularly limited, but is preferably 300 μm or less, more preferably 100 μm or less, and even more preferably 20 μm or less from the viewpoint of reducing visibility. Meanwhile, from the viewpoint of protecting an adherend from damage, the thickness is preferably 10 μm or more, more preferably 50 μm or more, and even more preferably 100 μm or more.

In addition, a haze of the adhesive film 100 is also a factor affecting visibility. Hazes include an external haze, an internal haze, and a total haze in detail, and have a relationship of (external haze=total haze−internal haze). Among them, the total haze and the external haze particularly affect visibility.

Values thereof are not particularly limited, but if they are excessively large or too small, there is a possibility that the aforementioned conditions of a mean spacing Sm and an average tilt angle θa of the unevenness, and a 60-degess glossiness GL cannot be satisfied. In particular, the adhesive film 100 becomes whitish in a case where a haze is excessively large, and light is easily reflected on the surface of the adhesive film 100 in a case where a haze is excessively small, and in both cases, there is a possibility that the adhesive film 100 is easily recognized.

From the above viewpoint, a total haze of the adhesive film 100 is preferably 15% or more, more preferably 20% or more, and even more preferably 30% or more. Furthermore, it is preferably at 95% or less, more preferably 90% or less, and even more preferably 85% or less. Furthermore, an external haze of the adhesive film 100 is preferably 10% or more, more preferably 15% or more, and even more preferably 20% or more. Furthermore, it is preferably at 80% or less, more preferably 75% or less, and even more preferably 70% or less. Preferable ranges of the total haze and the external haze are the same in the second embodiment to be described later.

The total haze can be measured according to JIS K 7136 (2000 version). The measurement of the haze is performed using the surface of the base material 120 on the side of the uneven surface as a light emitting surface. The internal haze refers to a haze measured in a state where the influence of the uneven surface (the light emitting side at the time of haze measurement) on the haze is eliminated. For example, a triacetylcellulose (TAC) film is adhered to the surface on the light emitting side, thereby producing an evaluation sample in which the unevenness of the uneven surface is eliminated and a flat layer is formed, and a haze of the evaluation sample can be used as an internal haze. That is, the evaluation sample having a flat surface does not have a haze due to surface unevenness and has only an internal haze. Accordingly, the internal haze can be obtained by measuring the haze of this evaluation sample.

Hereinafter, each component constituting the adhesive film 100 of the present embodiment will be described.

<Base Material>

The base material 120 in the adhesive film 100 of the present embodiment has an uneven surface on a surface on a side opposite to a surface on which the adhesive layer 110 is provided. Due to this uneven surface, excessive reflection of light on the surface of the base material 120 is inhibited, and the adhesive film 100 becomes difficult to be visually recognized. In the uneven surface of the base material 120 in the present embodiment, in a case where the mean spacing of the unevenness is too small, light will be excessively scattered on the surface of the base material 120, and the base material 120 will appear white, and as a result, the adhesive film 100 becomes easily visible. Therefore, an influence on design properties of an adherend is increased.

From the above viewpoint, the mean spacing Sm of the unevenness on the uneven surface of the base material 120 is set to 45 μm or more. Furthermore, it is preferably 75 μm or more, and more preferably 100 μm or more.

On the other hand, the upper limit value of the mean spacing Sm of the unevenness on the uneven surface of the base material 120 is not particularly limited, but in a case where it is excessively large, it may be difficult to satisfy a condition of a 60-degree glossiness GL to be described later. Accordingly, the mean spacing Sm is preferably 500 μm or less, more preferably 300 μm or less, and even more preferably 200 μm or less.

An average tilt angle θa of the unevenness on the uneven surface of the base material 120 is also an important factor affecting visibility. In a case where an average tilt angle θa of the unevenness on the uneven surface of the base material 120 is excessively small, light reflection on the base material surface cannot be sufficiently inhibited, whereas in a case where it is excessively large, light scattering on the base material surface becomes excessive. Accordingly, in both cases, the base material 120 becomes easily visible, and the influence on design properties of an adherend is increased.

From the above viewpoint, an average tilt angle θa of the unevenness on the uneven surface of the base material 120 is 0.5° to 15°. In addition, an average tilt angle θa of the unevenness on the uneven surface of the base material 120 is preferably 1° or more, and more preferably 1.5° or more. Furthermore, it is preferably 10° or less, and more preferably 5° or less.

Furthermore, a glossiness of the uneven surface of the base material 120 is also an important factor affecting visibility. In a case where a glossiness of the base material surface is excessive, the base material 120 reflects light excessively, and the adhesive film 100 becomes easily visible. Accordingly, a 60-degree glossiness GL on the uneven surface of the base material 120 is set to 60% or less. Furthermore, it is preferably 30% or less, and more preferably 15% or less.

Meanwhile, the lower limit value of a 60-degree glossiness GL on the uneven surface of the base material 120 is not particularly limited, but in a case where it is excessively small, it may be difficult to satisfy the above-described conditions of a mean spacing Sm and an average tilt angle θa of the unevenness, resulting a case in which the base material 120 appears white, and the adhesive film 100 becomes easily visible. Accordingly, a 60-degree glossiness of the uneven surface of the base material 220 is preferably 2.5% or more, more preferably 5% or more, and even more preferably 7.5% or more.

In addition, a haze (external haze, internal haze, and total haze) of the base material 120 is also a factor affecting visibility, and a total haze and an external haze particularly affect visibility. Values thereof are not particularly limited, but if they are excessively large or too small, there is a possibility that the aforementioned conditions of a mean spacing Sm and an average tilt angle θa of the unevenness, and a 60-degree glossiness GL cannot be satisfied. In particular, the base material 120 becomes whitish in a case where a haze is excessively large, and light is easily reflected on the surface of the base material 120 in a case where a haze is excessively small, and in both cases, there is a possibility that the adhesive film 100 is easily recognized.

From the above viewpoint, a total haze of the base material 120 is preferably 15% or more, more preferably 25% or more, and even more preferably 40% or more. Furthermore, it is preferably at 95% or less, more preferably 90% or less, and even more preferably 85% or less. Furthermore, an external haze of the base material 120 is preferably 3% or more, more preferably 5% or more, and even more preferably 10% or more. Furthermore, it is preferably at 80% or less, more preferably 75% or less, and even more preferably 70% or less.

A material of the base material 120 in the present embodiment is not particularly limited as long as it is transparent, and various films can be used. Generally, the base material 120 is a resin film. Furthermore, the base material 120 may have a single-layer structure or a multilayer structure of two or more layers. In addition, the outermost layer of the base material 120 may be an antistatic layer, an antifouling layer, an anti-slip layer, an antibacterial layer, a release treatment layer, or the like.

In particular, the base material 120 in the adhesive film of the present embodiment preferably includes a release treatment layer formed on the uneven surface. In such a case, as described above, in a case where the adhesive film is wound into a roll shape to protect an adhesive surface, the adhesive surface and the base material are easily released from each other. The release treatment layer can be formed by applying a release treatment agent to the uneven surface of the base material by any method. Any appropriate release treatment agent can be adopted as the release treatment agent. For example, it is possible to use a silicone release agent, a fluorine release agent, a long-chain alkyl release agent, a low-molecular-weight polyethylene release agent, a low-molecular-weight polypropylene release agent, a rubber polymer, a phosphate ester surfactant, and the like.

A resin constituting the resin film is not particularly limited, and for example, it is possible to use a polyester resin, a polyolefin resin, a polyamide resin, a polyimide resin, a polyphenylene sulfide resin, a polycarbonate resin, a polyurethane resin, an ethylene-vinyl acetate resin, a fluorine resin such as polytetrafluoroethylene, an acrylic resin such as polymethyl methacrylate, and the like. The resin film may be formed using a resin material containing one kind of such a resin alone, or may be formed using a resin material in which two or more kinds are blended. The resin film may be unstretched or stretched (uniaxially stretched or biaxially stretched).

Preferred examples of resin materials include low-density polyethylene (LDPE), high-density polyethylene (HDPE), polypropylene, ether-based polyurethane, ester-based polyurethane, carbonate-based polyurethane, and the like. Particularly, from the viewpoint of workability, wear resistance, and weather resistance in embossing processing to be described below, carbonate polyurethanes are preferred.

The base material 120 may contain known additives as needed as long as the effects of the present invention are not impaired. For example, it is possible to appropriately blend in additives such as a light stabilizer such as an ultraviolet absorber, an antioxidant, an antistatic agent, a filler, a plasticizer, a slip agent, and an antiblocking agent. These additives can be used alone or in combination of two or more kinds thereof. An amount of additives blended in may be appropriately set within the range of an amount generally blended in.

A method for method for manufacturing a resin film is not particularly limited. For example, it is possible to adopt conventionally known general resin film molding methods such as extrusion molding, inflation molding, T-die cast molding, and calendar roll molding.

A method for forming the uneven surface on the base material 120 is not particularly limited, but the uneven surface is preferably formed by embossing processing. For example, an uneven surface having a specific shape can be formed on the base material 120 by applying heat to the base material 120 to soften the base material 120, and pressurizing it with an embossing mold.

In addition, it is also preferable to form an uneven surface of the base material 120 by applying a composition containing a binder resin (or a precursor thereof) and particles to the surface of the base material 120, and then curing the composition.

In the present invention, as a method of forming the uneven surface on the base material 120, it is possible to use a known method other than the above-mentioned methods. For example, an uneven surface can be formed on the base material 120 by screen printing or gravure printing, transfer by nanoimprint, or the like.

A thickness of the base material 120 in the present embodiment is not particularly limited, but by increasing a thickness, hardness is improved, and an ability to protect an adherend from damage is improved. Accordingly, a thickness of the base material 120 is preferably 120 μm or more, more preferably 50 μm or more, and even more preferably 80 μm or more. On the other hand, by reducing a thickness of the base material 120, the adhesive film 100 becomes less visible, and furthermore, the adhesive film 100 can be attached to adherends having various shapes because followability with respect to a rough surface or a curved surface is improved. Accordingly, a thickness of the base material 120 is preferably 200 μm or less, more preferably 150 μm or less, and even more preferably 100 μm or less.

<Adhesive Layer>

The adhesive layer 110 in the present embodiment is a layer having an adhesive force provided for attaching the base material 120 to an object, and is a layer formed of an adhesive which is provided on at least a part of a surface of the base material 120 on a side opposite to the uneven surface.

Components of the adhesive forming the adhesive layer 110 in the present embodiment are not particularly limited as long as they are transparent, and it is possible to use acrylic adhesives, rubber adhesives, polyester adhesives, polyurethane adhesives, silicone adhesives, and the like, but it is preferable to use at least one adhesive selected from the group consisting of acrylic adhesives and rubber adhesives.

The acrylic adhesive refers to an adhesive containing an acrylic copolymer as a base polymer, and the rubber adhesive refers to an adhesive containing a rubber copolymer as a base polymer. The base polymer refers to the main component (the component having the largest blending ratio; the same applies hereinafter) among polymer components contained in the adhesive, and typically, it refers to a component accounting for more than 50% by weight of the polymer components.

As the acrylic adhesive, for example, it is possible to preferably use an acrylic adhesive containing an acrylic polymer having a monomer composition in which an alkyl (meth)acrylate such as butyl (meth)acrylate or 2-ethylhexyl (meth)acrylate is contained a main component, and a modifying monomer that can be copolymerized with the alkyl (meth)acrylate may be added as necessary, as a base polymer (a main component of polymer components). Examples of modifying monomers include hydroxyl-containing monomers such as 2-hydroxyethyl (meth)acrylate; carboxyl-containing monomers such as (meth)acrylic acid; styrene monomers such as styrene; vinyl esters such as vinyl acetate; and the like. Such an acrylic adhesive can be obtained by a conventional polymerization method such as a solution polymerization method, an emulsion polymerization method, and an ultraviolet (UV) polymerization method.

Examples of rubber adhesives include a natural rubber adhesive, a synthetic rubber adhesive, and the like. Specific examples of rubber polymers as a base polymer of a synthetic rubber adhesive include styrene elastomers such as polybutadiene, polyisoprene, butyl rubber, polyisobutylene, and a styrene-butadiene-styrene block copolymer; styrene elastomers such as a styrene-ethylenebutylene-styrene block copolymer and a styrene-ethylenebutylene random copolymer; ethylene propylene rubbers; propylene butene rubbers; ethylene propylene butene rubbers; and the like.

In addition, as necessary, the adhesive forming the adhesive layer 110 in the present embodiment may contain various additives generally used in the field of adhesives such as crosslinking agents, tackifiers such as rosin resins, release regulators, antistatic agents, slip agents, antiblocking agents, leveling agents, fillers, pH regulators, dispersants, stabilizers, preservatives, and antiaging agents, within a range that does not impair the effects of the present invention. As for such various additives, conventionally known additives may be used in a conventional manner.

In addition, the adhesive layer 110 according to the present embodiment preferably has a storage elastic modulus at 23° C. (hereinafter, also simply referred to as a “storage elastic modulus”) of 1×10⁶ Pa or less, the storage elastic modulus being measured by dynamic viscoelasticity measurement under a condition of a shear strain at a frequency of 1 Hz.

By setting the storage elastic modulus to 1×10⁶ Pa or less, shape followability of the adhesive layer 110 can be improved, and adhesive properties of the adhesive film 100 to a rough surface or a curved surface can be improved. Accordingly, air bubbles are unlikely to be sealed between the adhesive film 100 and an adhered surface in a case where the adhesive film 100 is adhered to a rough surface or a curved surface, and thereby it is possible to prevent air bubbles from making the film easily visually recognized. Furthermore, a storage elastic modulus of the adhesive layer 110 is more preferably 5×10⁵ Pa or less, and even more preferably 3×10⁵ Pa or less.

A thickness of the adhesive layer 110 in the present embodiment is not particularly limited, but by increasing the thickness, shape followability of the adhesive layer 110 can be improved, and adhesive properties to a rough surface or a curved surface of the adhesive film 100 can be improved. Accordingly, a thickness of the adhesive layer 110 is preferably 10 μm or more, more preferably 30 μm or more, and even more preferably 50 μm or more. On the other hand, by reducing a thickness of the adhesive layer 110, the adhesive film 100 becomes less visible. Accordingly, a thickness of the adhesive layer 110 is preferably 200 μm or less, more preferably 150 μm or less, and even more preferably 100 μm or less.

<Method for Manufacturing Adhesive Film>

A method for manufacturing the adhesive film 100 of the present embodiment is not particularly limited, and the adhesive film 100 can be manufactured using a known method.

The adhesive layer is formed using an adhesive composition containing an adhesive, a solvent, and the like. The adhesive composition is not particularly limited, and examples thereof include a water adhesive composition, a solvent-type adhesive composition, a hot-melt-type adhesive composition, an active-energy-ray-curable-type adhesive composition, and the like.

A method for forming the adhesive layer is not particularly limited, and for example, the adhesive layer can be formed by a conventionally known method such as a direct method or a transfer method described below.

The direct method is a method in which an adhesive composition is applied to a base material and dried to form an adhesive layer. The transfer method is a method in which an adhesive composition is applied to release paper or the like and dried to form an adhesive layer, and the adhesive layer is transferred to a base material. Application of the adhesive can be performed using a conventionally known coater such as a gravure roll coater, a die coater, and a bar coater. Alternatively, the adhesive composition may be applied by impregnation, curtain coating, or the like.

In the case of the direct method, a temperature at the time of drying needs to be a temperature that does not impair an uneven shape formed on a surface of a base material. In addition, it is necessary to select a solvent that does not dissolve or swell a base material as a solvent to be contained in the adhesive composition. On the other hand, in the transfer method, because it is not necessary to heat a base material and a solvent to be contained in the adhesive composition does not come into contact with the base material, there is little risk of damaging projections and recesses of the base material. For this reason, it is preferable to form the adhesive layer by a transfer method.

### Second Embodiment

<Transparent Adhesive Film>

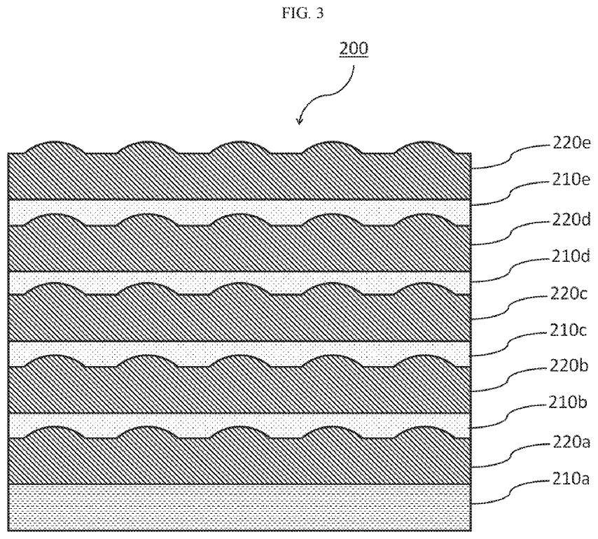

FIG. 2 is a schematic cross-sectional view of one aspect of a transparent adhesive film according to a second embodiment of the present invention. FIG. 3 is a schematic cross-sectional view of another aspect of the transparent adhesive film according to the second embodiment of the present invention.

An adhesive film 200 of the present embodiment includes two or more laminate units each including a base material and an adhesive layer. The adhesive film 200 of the embodiment shown in FIG. 2 includes a laminate unit (a first laminate unit) having a base material 220a (a first base material 220a) and an adhesive layer 210a (a first adhesive layer 210a); and a laminate unit (a second laminate unit) having a base material 220b (a second base material 220b) and an adhesive layer 210b (a second adhesive layer 210b). That is, the adhesive film 200 includes two laminate units each having a base material and an adhesive layer, and the second adhesive layer 210b is laminated on an uneven surface of the first base material 220a. Furthermore, an adhesive film 200 of the embodiment shown in FIG. 3 includes five laminate units each including a base material and an adhesive layer.

Hereinafter, the adhesive layer positioned on the outermost side of the adhesive film 200 may be referred to as an “adhesive layer for sticking.” In addition, an adhesive layer other than the adhesive layer for sticking, that is, an adhesive layer positioned between base materials may be referred to as an “interlayer adhesive layer.” That is, in the embodiment shown in FIG. 2, the first adhesive layer 210a is an adhesive layer for sticking, and the second adhesive layer 210b is an interlayer adhesive layer. Furthermore, in the embodiment shown in FIG. 3, a first adhesive layer 210a is an adhesive layer for sticking, and second to fifth adhesive layers 210b, 210c, 210d, and 210e are interlayer adhesive layers.

The adhesive film of the present embodiment is used by being attached to an adherend via the adhesive layer for sticking.

In the adhesive film according to the present embodiment, only the laminate unit positioned at the outermost surface can be released from and discarded to expose a new base material inside to the outermost surface. In other words, in a case where the adhesive film becomes easily visible due to damage or contamination of the base material positioned at the outermost surface, visibility can be reduced again by releasing the laminate unit including the base material positioned at the outermost surface to expose a new base material.

As the number of laminate units constituting the adhesive film increases, the number of times that the laminate unit on the outermost surface can be released is increased, which is preferable, but from the viewpoint of visibility, the number of laminate units is preferably small. Accordingly, the number of laminate units is preferably 20 or less, more preferably 15 or less, and even more preferably 10 or less.

Before the adhesive film of the present embodiment is attached to an adherend, an adhesive surface is preferably protected by the method exemplified in the description of the first embodiment.

A thickness of the adhesive film of the present embodiment is not particularly limited, but is preferably 400 μm or less, more preferably 300 μm or less, and even more preferably 200 μm or less from the viewpoint of reducing visibility. Meanwhile, from the viewpoint of protecting an adherend from damage, or securing the number of laminate units, the thickness is preferably 5 μm or more, more preferably 10 μm or more, and even more preferably 20 μm or more.

Hereinafter, each component constituting the adhesive film of the present embodiment will be described.

<Base Material>

As a base material in the adhesive film of the present embodiment, the same base material as in the first embodiment can be used.

In the adhesive film of the present embodiment, base materials of the respective laminate units may be the same as or different from each other. That is, the adhesive film of the present embodiment may include a plurality of types of base materials of different materials, shapes, and the like.

Among the base materials in the adhesive film of the present embodiment, a base material other than base materials positioned at the outermost side, that is, a base material positioned between adhesive layers preferably includes a release treatment layer formed on an uneven surface. In such a case, the above-described releasing of the laminate unit at the outermost surface becomes easy.

In addition, a base material positioned on the outermost side preferably has a release treatment layer. In such a case, as described in the first embodiment, an adhesive surface can be easily released from the base material positioned at the outermost side in a case of protecting an adhesive surface by winding the adhesive film into a roll shape.

<Adhesive Layer for Sticking>

The adhesive layer for sticking in the present embodiment is an adhesive layer positioned at the outermost side of the adhesive film, and is a layer with an adhesive force which is provided for bonding the adhesive film to an object. The same adhesive layer as the adhesive layer in the first embodiment can be used as the adhesive layer for sticking in the present embodiment.

<Interlayer Adhesive Layer>

The interlayer adhesive layer in the present embodiment is an adhesive layer other than adhesive layers positioned at the outermost side of the transparent adhesive film, that is, an adhesive layer positioned between base materials; and is a layer provided for bonding base materials to each other.

Components of an adhesive forming the interlayer adhesive layer in the present embodiment are the same as the components of the adhesive forming the adhesive layer in the first embodiment.

In the adhesive film of the present embodiment, the adhesive layer for sticking and the interlayer adhesive layer may be the same as or different from each other. In addition, in a case where the adhesive film of the present embodiment includes a plurality of interlayer adhesive layers, the respective interlayer adhesive layers may be the same as or different from each other. That is, the adhesive film of the present embodiment may include a plurality of types of adhesive layers of different materials and shapes.

A thickness of the interlayer adhesive layer in the present embodiment is preferably 5 times or more a surface roughness Ra of an uneven surface of a base material of which the uneven surface is adhered to the interlayer adhesive layer. That is, in FIG. 2, a thickness of the adhesive layer 210b is preferably 5 times or more a surface roughness Ra of an uneven surface of the base material 220a. In FIG. 3, a thickness of each of the adhesive layers 210b, 210c, 210d, and 210e is preferably 5 times or more a surface roughness Ra of each of an uneven surface of the base materials 220a, 220b, 220c, and 220d. In addition, a thickness of the interlayer adhesive layer in the present embodiment is more preferably 7.5 times or more, and even more preferably 10 times or more a surface roughness Ra of an uneven surface of a base material of which the uneven surface is adhered to the interlayer adhesive layer. In such a case, particularly, air bubbles can be inhibited from being mixed between the respective laminate units, and thereby visibility of the adhesive film 200 can be further reduced. Meanwhile, the adhesive film also becomes less visible by reducing a thickness of the interlayer adhesive layer. Accordingly, a thickness of the interlayer adhesive layer is preferably 200 μm or less, more preferably 100 μm or less, and even more preferably 50 μm or less.

The interlayer adhesive layer in the present embodiment preferably has a storage elastic modulus of 1.0×10⁶ Pa or less. In addition, it is more preferably 5.0×10⁵ Pa or less, and even more preferably 3.0×10⁵ Pa or less. In such a case, shape followability of the interlayer adhesive layer can be improved, and particularly, air bubbles can be inhibited from being mixed between the respective laminate units, and thereby visibility of the adhesive film can be further reduced.

On the other hand, from the viewpoint of preventing an adhesive layer of a released laminate unit from remaining on an uneven surface side of a newly exposed base material after releasing the laminate unit on the outermost surface, a storage elastic modulus of the interlayer adhesive layer is preferably 7.5×10⁴ Pa or more, more preferably 1.0×10⁵ Pa or more, and even more preferably 2.0×10⁵ Pa or more.

<<Method for Manufacturing Adhesive Film>

A method for manufacturing the adhesive film of the present embodiment is not particularly limited. For example, by the method described in the section of the first embodiment, it is possible to obtain the adhesive film of the present embodiment by manufacturing a laminate unit including a base material and an adhesive layer, and laminating a plurality of obtained laminate units. After laminating the plurality of laminate units, it is preferable to press the adhesive film in a thickness direction using a laminator or the like. By applying pressure in the thickness direction of the adhesive film, it is possible to inhibit air bubbles from entering between laminate units.

### EXAMPLES

Hereinafter, the effects of the present invention will be described more specifically with reference to Examples and Comparative Examples, but the present invention is not limited thereto.

[Production of Base Materials 1 to 15]

<Base Material 1>

5 parts by weight of a photopolymerization initiator (trade name: IRGACURE 184, manufactured by BASF), 6.5 parts by weight of silica particles having a particle diameter of 1.4 μm (trade name: Silo Hovic 100, manufactured by Fuji Silysia Ltd.), 7.5 parts by weight of silica particles having a particle diameter of 2.5 μm (trade name: Silo Hovic 702, manufactured by Fuji Silysia), 0.5 part by weight of a fluorine additive (trade name: Megafac F-556, manufactured by Dainippon Ink and Chemicals) were mixed to 100 parts by weight of a solid content of a UV-curable urethane acrylate resin (concentration of solid contents: 80% by weight, trade name: UNIDIC17-806, manufactured by Dainippon Ink and Chemicals Inc.), and this mixture was diluted with a solvent (toluene) so that a concentration of solid contents became 47% by weight, and thereby a material 1 for forming an anti-glaring hard coating layer was prepared.

The prepared material 1 for forming an anti-glaring hard coating layer was applied to a triacetyl cellulose base material having a long side of 30 cm, a short side of 20 cm, and a thickness of 40 μm, and heated at 80° C. for 1 minute to dry a coated film. Thereafter, with a high-pressure mercury lamp ultraviolet rays were irradiated having an integrated light amount of 300 mJ/cm² to cure the coated film, and the coated film having a thickness of 6 μm was formed. Thereby, a base material 1 was obtained.

<Base Material 2>

The following substances were mixed: 70 parts by weight of a UV-curable urethane acrylate resin (a concentration of solid contents content: 100% by weight, trade name: UV1700B, manufactured by Nippon Synthetic Chemical Industry Co., Ltd.), 30 parts by weight of a multifunctional acrylate containing pentaeristol triacrylate as a main component (a concentration of solid contents: 100%, trade name: Viscoat #300, manufactured by Osaka Organic Chemical Industry Co., Ltd.), 3 parts by weight of a photopolymerization initiator (trade name: IRGACURE907, manufactured by BASF), 2 parts by weight of 3.0-μm acrylic and styrene copolymer particles (a weight average particle diameter: 3.0 μm, trade name: Techpolymer, manufactured by Sekisui Chemical Co., Ltd.), 0.4 parts by weight of synthetic smectite, an organic clay (trade name: Lucentite SAN, manufactured by Corp Chemical Co., Ltd.), and 0.5 part by weight of a leveling agent (a concentration of solid contents: 10%, trade name: PC4100, manufactured by DIC Corporation). The organic clay was used after being diluted with toluene so that a solid content became 6%. This mixture was diluted with a mixed solvent of toluene/cyclopentanone (a weight ratio: 80/20) so that a concentration of solid contents became 50% by weight, thereby preparing a material 2 for forming an anti-glaring hard coating layer.

The prepared material 2 for forming an anti-glaring hard coating layer was applied to a triacetyl cellulose base material having a long side of 30 cm, a short side of 20 cm, and a thickness of 40 μm, and heated at 80° C. for 1 minute to dry a coated film. Thereafter, with a high-pressure mercury lamp ultraviolet rays were irradiated having an integrated light amount of 300 mJ/cm² to cure the coated film, and the coated film having a thickness of 6 μm was formed. Thereby, a base material 2 was obtained.

<Base Materials 3 to 15>

Various polishing was performed on a mirror-surfaced SUS metal plate having a thickness of 2 mm to produce a SUS metal plate having various forms of projections and recesses. To this metal plate, a smooth carbonate-based polyurethane base material having a long side of 30 cm, a short side of 20 cm, and a thickness of 80 μm was attached. Thereafter, heat and pressure transfer was performed at 150° C. and 0.1 MPa using a laminator, and cooling was performed to room temperature. Thereafter, the carbonate-based polyurethane base material was released from the SUS metal plate having unevenness, and thereby base materials 3 to 14 were obtained. In addition, a smooth base material 15 was obtained in the same manner as above except that the transfer under heat and pressure was performed under a condition of 0.1 MPa using a mirror-surfaced SUS metal plate having no unevenness.

[Measurement of Physical Properties of Base Materials]

<Measurement of 60-Degree Glossiness>

A 60-degree glossiness of each of the base materials 1 to 15 was measured according to JIS Z 8741 (1997 edition). Specifically, the measurement was performed using True Gloss GM-26PRO (60° gloss measurement, manufactured by Murakami Color Research Laboratory). The measurement was performed five times for the respective base materials, and an average value therefrom was defined as a 60-degree glossiness of the base materials. Table 1 shows the results.

<Measurement of Shape (Ra, Sm, θa) of Uneven Surface>

A mean spacing Sm (mm) of the unevenness and an arithmetic average surface roughness Ra (μm) of the uneven surface of each of the base materials were measured according to JIS B 0601 (1994 version). More specifically, a glass plate (MICRO SLIDE GLASS, product number S, thickness: 1.3 mm, 45×50 mm manufactured by MATSUNAMI) was attached to a surface of each of the base materials 1 to 15 on a side opposite to the uneven surface using an adhesive, and thereby samples were prepared. A surface shape of the uneven surface on each of the base materials 1 to 10 was measured in a set direction under conditions of a scanning speed of 1 mm/sec, a cutoff value of 0.8 mm, and a measurement length of 36 mm using a stylus type surface roughness measuring instrument having a measuring needle in which a radius of curvature R of a tip end portion (diamond) was 2 μm (manufactured by Kosaka Laboratory Co., Ltd., a high-precision fine-shape-measuring instrument, trade name “SURFCORDER ET4000”). Thereby, a mean spacing Sm (mm) of the unevenness and an arithmetic average surface roughness Ra were obtained. Furthermore, an average tilt angle θa (°) of the unevenness was obtained from the obtained surface roughness curve. Table 1 shows the results. The high-precision fine-shape-measuring instrument automatically calculates the measured values.

<Haze Measurement>

A total haze, an internal haze, and an external haze of each of the base materials 1 to 15 were obtained according to JIS K7136 (2000 version). The haze was measured using the surface of each of the base materials on the uneven surface side as a light emitting surface. The internal haze was measured in a state where a triacetyl cellulose film was adhered to the uneven surface of each of the base materials, whereby surface unevenness of the uneven surface were removed and a flat layer was formed. Table 1 shows the results.

[Manufacture of Adhesive Films 1 to 15]

An adhesive layer with a thickness of 100 μm, which is formed of an acrylic adhesive having a copolymer of 95 parts by weight of butyl acrylate (BA) and 5 parts by weight of acrylic acid (AA) as a base polymer, was attached to the surface of each of the produced base materials 1 to 15 on the side opposite to the uneven surface using a laminator, and thereby adhesive films 1 to 15 were obtained.

[Evaluation of Adhesive Films 1 to 15]

<Visibility Evaluation>

The obtained adhesive films 1 to 15 were attached to a flooring board (a 1.5 mm WPB reform floor, with hinoki patterns, manufactured by Panasonic Corporation), and visibility of each of the base materials was visually evaluated. The evaluation gave 5 grades which are: 5 (an adhesive film could not be visually recognized at all), 4 (an adhesive film could not be visually recognized), 3 (an adhesive film almost could not be visually recognized at all), 2 (an adhesive film could be visually recognized depending on angles and the like), and 1 (an adhesive film could be clearly visually recognized). In the evaluation, a flooring board to which sheets were attached was placed under a fluorescent lamp, and visibility when viewed from a distance of 1 m was evaluated. The evaluation was performed by ten persons, and an average value of the evaluation results of ten persons was used as the evaluation results of the visibility evaluation. Table 1 shows the results.

TABLE 1

| | Haze | | | Glossiness | Surface shape | | | Visibility | |
|---|---|---|---|---|---|---|---|---|---|
| | Total | Internal | External | GL | Ra | Sm | θa | Eval- | |
| No. | (%) | (%) | (%) | (%) | (μm) | (μm) | (°) | uation | Remark |
| 1 | 25.0 | 21.0 | 4.0 | 20.0 | 0.310 | 80 | 3.5 | 4 | |
| 2 | 3.4 | 2.3 | 1.1 | 84.7 | 0.070 | 190 | 0.3 | 1 | |
| 3 | 77.2 | 6.3 | 70.9 | 12.7 | 1.384 | 75 | 13.81 | 4 | |
| 4 | 44.6 | 17.5 | 27.1 | 22.8 | 0.466 | 93 | 5.19 | 4 | |
| 5 | 87.1 | 63.8 | 23.3 | 9.3 | 1.596 | 58 | 16.42 | 1 | Some white turbidity |
| 6 | 81.9 | 40.2 | 41.7 | 9.8 | 1.139 | 87 | 10.23 | 4 | |
| 7 | 84.4 | 39.1 | 45.3 | 9.4 | 1.033 | 70 | 11.22 | 2 | |
| 8 | 88.7 | 51.2 | 37.5 | 11.1 | 2.596 | 64 | 22.52 | 1 | White |
| 9 | 83.1 | 22.7 | 60.4 | 10.3 | 0.828 | 196 | 3.74 | 5 | |
| 10 | 32.2 | 6.9 | 25.3 | 41.6 | 0.475 | 53 | 6.85 | 3 | |
| 11 | 26.5 | 20.5 | 5.8 | 86.4 | 0.124 | 140 | <0.5 | 1 | Glossy |
| 12 | 42.1 | 29.1 | 12.8 | 56.2 | 0.152 | 70 | 1.7 | 3 | |
| 13 | 22.7 | 6.5 | 16.3 | 65.4 | 0.527 | 41 | 8.6 | 1 | White |
| 14 | 71.9 | 20.6 | 51.3 | 15.3 | 1.168 | 48.5 | 13.1 | 4 | |
| 15 | 2.5 | 1.4 | 1.1 | 89.4 | 0 | 0 | 0 | 1 | Glossy |

The adhesive films 1, 3, 4, 6, 7, 9, 10, 12, and 14 satisfying the conditions of the present invention were not almost visually recognized.

On the other hand, the adhesive film 2 was easily visually recognized because its average tilt angle θa of the unevenness of the uneven surface was smaller than the range specified in the present invention, and its 60-degree glossiness GL on the uneven surface was larger than the range specified in the present invention.

Furthermore, the adhesive film 5 was easily visually recognized because its average tilt angle θa of the unevenness of the uneven surface was larger than the range specified in the present invention, and it appeared white.

Furthermore, the adhesive film 8 was easily visually recognized because its average tilt angle θa of the unevenness of the uneven surface was larger than the range specified in the present invention, and it appeared white.

Meanwhile, the adhesive film 13 was easily visually recognized because its average tilt angle θa of the unevenness of the uneven surface was smaller than the range specified in the present invention, and its 60-degree glossiness GL on the uneven surface was larger than the range specified in the present invention.

Furthermore, the adhesive film 15 was easily visually recognized because it did not have an uneven surface, and light was reflected and viewed.

[Manufacture of Adhesive Films 16 to 30]

<Adhesive Films 16 to 23>

An adhesive layer of a first laminate unit formed of an acrylic adhesive, a base material of the first laminate unit, an adhesive layer of a second laminate unit formed of an acrylic adhesive, and a base material of the second laminate unit were laminated in this order, and bonded with a laminator, and thereby adhesive films 16 to 23 each having two laminate units as shown in FIG. 2 were obtained. A thickness and a storage elastic modulus of the adhesive layer, and the type of the base material are as shown in Table 2.

As shown in FIG. 2, lamination was performed such that a surface of the base material on a side opposite to an uneven surface of the first laminate unit came into contact with the adhesive layer of the first laminate unit, and a surface of the base material on a side opposite to an uneven surface of the second laminate unit came into contact with the adhesive layer of the second laminate unit. That is, the first laminate unit is a laminate unit on an adherend side (a laminate unit formed of the base material 220a and the adhesive layer 210a in FIG. 2).

Furthermore, a release treatment layer was formed on the uneven surface of the base material of the first laminate unit using a long-chain alkyl release treatment agent.

<Adhesive Films 24 to 30>

Adhesive films 24 to 30 each having five laminate units were obtained as shown in FIG. 3 in the same manner as in the adhesive films 16 to 23 except that the number of laminate units was increased. A thickness and a storage elastic modulus of the adhesive layers, and the type of the base material are as shown in Table 3.

In addition, for the adhesive films 24 to 29, a release treatment layer was formed on the uneven surface of the base material of each of the first to fourth laminate units using a long-chain alkyl release treatment agent; and for the adhesive film 30, a release treatment layer was formed on the uneven surface of the base material of each of the first to fourth laminate units using a silicone release treatment agent.

[Evaluation of Adhesive Films 16 to 30]

<Haze Measurement>

An internal haze and an external haze of each of the adhesive films 16 to 30 were obtained in the same manner as in the measurement of the haze of each of the base materials 1 to 15 described above. The results are shown in Tables 2 and 3.

<Gloss Level>

With a measurement angle set to 60°, a glossiness of each of the adhesive films 16 to 30 was measured using a digital variable-angle gloss meter UGV-5DP manufactured by Suga Test Instruments Co., Ltd. according to JIS K7105-1981. The results are shown in Tables 2 and 3.

<Visibility Evaluation>

Visibility evaluation was performed on each of the adhesive films 16 to 30 in the same manner as the visibility evaluation of the adhesive films 1 to 15 described above. The results are shown in Tables 2 and 3.

<Measurement of Thickness>

A thickness of each of the adhesive films 16 to 30 was measured using a digital gauge R1-205 manufactured by Ozaki Seisakusho Co., Ltd. The results are shown in Tables 2 and 3.

<Releasability Evaluation>

Among the laminate units constituting the adhesive films of the respective examples, the first laminate unit was laminated to an acrylic plate. Thereafter, the second laminate unit was cut out to 50 mm in width and 10 cm in length, and was bonded on the first laminate unit using a laminator under a pressure of 0.5 MPa. Thereafter, a releasing force of the second laminate unit was measured at a 180-degree angle in a longitudinal direction at a tensile speed of 300 mm/min using Autograph AGS-50NX manufactured by Shimadzu Corporation. According to the measured releasing force, releasability was evaluated according to the following criteria. The results are shown in Tables 2 and 3.

(Evaluation Criteria for Releasability)

A (particularly favorable): a releasing force was less than 1N

B (favorable): a releasing force was 1N or more and less than 2N

C (slightly poor): a releasing force was 2N or more

TABLE 2

| | | | | No. | | | | | | | |
|---|---|---|---|---|---|---|---|---|---|---|---|
| | | | | 16 | 17 | 18 | 19 | 20 | 21 | 22 | 23 |
| Configuration | Second | Base | Type | Base material 9 | | | | Base material 14 | | Base | Base |
| | laminate | material | | | | | | | | material | material |
| | unit | | | | | | | | | 15 | 8 |
| | | | Thickness | 100 | | | | 20 | | 100 | 100 |
| | | | (μm) | | | | | | | | |
| | | | Sm (μm) | 196 | | | | 48.5 | | 0 | 64 |
| | | | θa (°) | 3.74 | | | | 13.1 | | 0 | 22.52 |
| | | | GL (%) | 10.3 | | | | 15.3 | | 100 | 11.1 |
| | | | Ra (μm) | 0.828 | | | | 1.168 | | 0 | 2.596 |
| | | Adhesive | Thickness | 10 | 8 | 6 | 10 | 10 | 8 | 200 | 200 |
| | | layer | (μm) | | | | | | | | |
| | | | Storage | 1.3 | 1.3 | 1.3 | 1.3 | 1.3 | 1.3 | 1.0 | 1.0 |
| | | | elastic | | | | | | | | |
| | | | modulus | | | | | | | | |
| | | | (10⁵ Pa) | | | | | | | | |
| | First | Base | Type | Base | Base | Base | Base | Base | Base | Base | Base |
| | laminate | material | | material | material | material | material | material | material | material | material |
| | unit | | | 9 | 9 | 9 | 14 | 3 | 3 | 15 | 8 |
| | (on | | Thickness | 100 | | | 20 | 50 | | 100 | 100 |
| | adherend | | (μm) | | | | | | | | |
| | side) | | Sm (μm) | 196 | | | 48.5 | 75 | | 0 | 64 |
| | | | θa (°) | 3.74 | | | 13.1 | 13.81 | | 0 | 22.52 |
| | | | GL (%) | 10.3 | | | 15.3 | 12.7 | | 100 | 11.1 |
| | | | Ra (μm) | 0.828 | | | 1.168 | 1.384 | | 0 | 2.596 |
| | | Adhesive | Thickness | 200 | 200 | 200 | 200 | 200 | 200 | 200 | 200 |
| | | layer | (μm) | | | | | | | | |
| | | | Storage | 1.0 | 1.0 | 1.0 | 1.0 | 1.0 | 1.0 | 1.0 | 1.0 |
| | | | elastic | | | | | | | | |
| | | | modulus | | | | | | | | |
| | | | (10⁵ Pa) | | | | | | | | |

| Evaluation | Haze | Internal | 4.5 | 4.1 | 4.6 | 6.7 | 7.1 | 6.8 | 0.6 | 37.5 |
|---|---|---|---|---|---|---|---|---|---|---|
| | | External | 60.9 | 59.8 | 60.3 | 50.9 | 50.9 | 53.1 | 0.5 | 51.2 |
| | Gloss level (%) | | 10.3 | 11.2 | 10.8 | 15.3 | 16.2 | 15.8 | 90.2 | 11.1 |
| | Visibility | Evaluation | 4 | 4 | 3 | 5 | 4 | 3 | 1 | 1 |
| | | Remark | | | | | | | Glossy | White |

| | | | | | | | | |
|---|---|---|---|---|---|---|---|---|
| Thickness (μm) | 410 | 408 | 406 | 330 | 280 | 278 | 600 | 600 |
| Releasability | A | A | A | B | A | A | A | A |

TABLE 3

| | | | | No. | | | | | | |
|---|---|---|---|---|---|---|---|---|---|---|
| | | | | 24 | 25 | 26 | 27 | 28 | 29 | 30 |
| Configuration | Fifth | Base | Type | Base | Base | Base | Base | Base | Base | Base |
| | laminate | material | | material | material | material | material | material | material | material |
| | unit | | | 9 | 14 | 14 | 14 | 9 | 14 | 14 |
| | | | Thickness | 100 | 20 | | | 100 | 20 | |
| | | | (μm) | | | | | | | |
| | | | Sm (μm) | 196 | 48.5 | | | 196 | 48.5 | |
| | | | θa (°) | 3.74 | 13.1 | | | 3.74 | 13.1 | |
| | | | GL (%) | 10.3 | 15.3 | | | 10.3 | 15.3 | |
| | | | Ra (μm) | 0.828 | 1.168 | | | 0.828 | 1.168 | |
| | | Adhesive | Thickness | 10 | 10 | 10 | 10 | 10 | 10 | 10 |
| | | layer | (μm) | | | | | | | |
| | | | Storage | 1.3 | 1.3 | 1.3 | 1.3 | 1.3 | 0.9 | 1.3 |
| | | | elastic | | | | | | | |
| | | | modulus | | | | | | | |
| | | | (10⁵ Pa) | | | | | | | |
| | Second to | Base | Type | Base | Base | Base | Base | Base | Base | Base |
| | fourth | material | | material | material | material | material | material | material | material |
| | laminate | | | 9 | 14 | 14 | 14 | 14 | 14 | 14 |
| | units | | Thickness | 100 | 20 | | | | | |
| | | | (μm) | | | | | | | |
| | | | Sm (μm) | 196 | 48.5 | | | | | |
| | | | θa (°) | 3.74 | 13.1 | | | | | |
| | | | GL (%) | 10.3 | 15.3 | | | | | |
| | | | Ra (μm) | 0.828 | 1.168 | | | | | |
| | | Adhesive | Thickness | 10 | 10 | 10 | 10 | 10 | 10 | 10 |
| | | layer | (μm) | | | | | | | |
| | | | Storage | 1.3 | 1.3 | 1.3 | 1.3 | 1.3 | 0.9 | 1.3 |
| | | | elastic | | | | | | | |
| | | | modulus | | | | | | | |
| | | | (10⁵ Pa) | | | | | | | |
| | First | Base | Type | Base | Base | Base | Base | Base | Base | Base |
| | laminate | material | | material | material | material | material | material | material | material |
| | unit | | | 9 | 9 | 1 | 3 | 9 | 9 | 9 |
| | (on | | Thickness | 100 | | 80 | 50 | 100 | | |
| | adherend | | (μm) | | | | | | | |
| | side) | | Sm (μm) | 196 | | 80 | 75 | 196 | | |
| | | | θa (°) | 3.74 | | 3.5 | 13.81 | 3.74 | | |
| | | | GL (%) | 10.3 | | 20 | 12.7 | 10.3 | | |
| | | | Ra (μm) | 0.828 | | 0.31 | 1.384 | 0.828 | | |
| | | Adhesive | Thickness | 200 | 200 | 200 | 200 | 200 | 290 | 200 |
| | | layer | (μm) | | | | | | | |
| | | | Storage | 1.0 | 1.0 | 1.0 | 1.0 | 1.0 | 1.0 | 1.0 |
| | | | elastic | | | | | | | |
| | | | modulus | | | | | | | |
| | | | (10⁵ Pa) | | | | | | | |

| Evaluation | Haze | Internal | 13.1 | 18.9 | 21.5 | 19.3 | 12.8 | 18.8 | 17.4 |
|---|---|---|---|---|---|---|---|---|---|
| | | External | 61.3 | 56.3 | 57.4 | 61.9 | 60.5 | 55.7 | 51.8 |
| | Gloss level (%) | | 10.6 | 16.1 | 20 | 12.7 | 10.9 | 15.7 | 16.3 |
| | Visibility | Evaluation | 3 | 4 | 4 | 4 | 3 | 4 | 4 |

| | | | | | | | |
|---|---|---|---|---|---|---|---|
| Thickness (μm) | 740 | 420 | 400 | 370 | 500 | 420 | 420 |
| Releasability | A | B | B | B | A | B | B |

The adhesive film 22 was easily visually recognized because the base material 15 of the outermost layer (the second laminate unit) did not have an uneven surface, and light was reflected and viewed.

Furthermore, the adhesive film 23 was easily visually recognized because an average tilt angle θa of the unevenness of the uneven surface of the base material 8 of the outermost layer (the second laminate unit) was larger than the range specified in the present invention, and it appeared white.

On the other hand, the adhesive films 16 to 21 and 24 to 30 satisfying the conditions of the present invention were difficult to be visually recognized. In addition, since the adhesive films 16 to 21 and 24 to 30 also have favorable releasability, visibility can be easily reduced again by releasing the laminate unit including the base material to expose a new base material in a case where the base material positioned at the outermost surface became easily visible.

Although the preferred embodiments of the present invention have been described above, the present invention is not limited to the above-described embodiments, and various modifications and substitutions may be made to the above-described embodiments without departing from the scope of the present invention.

The adhesive film of the present invention can be typically used for the purpose of protecting products from damage, but it is not limited thereto. For example, it can be used for locking, repairing, and the like of products.

Although the present invention has been described in detail with reference to particular embodiments, it will be apparent to those skilled in the art that various changes and modifications can be made without departing from the spirit and scope of the invention. This application is based on Japanese patent application filed on Sep. 29, 2017 (Japanese Patent Application No. 2017-191818) and Japanese patent application filed on Sep. 27, 2018 (Japanese Patent Application No. 2018-181115), and is incorporated by reference in its entirety. In addition, all references cited herein are incorporated in their entirety.

### REFERENCE SIGNS LIST

100: adhesive film
110: adhesive layer
120: base material
200: adhesive film
210: an adhesive layer for sticking
210b, 210c, 210d, 210e: interlayer adhesive layer
220a, 220b, 220c, 220d, 220e: base material

1. A transparent adhesive film comprising:
a base material having an uneven surface; and
an adhesive layer laminated on a surface of the base material on a side opposite to the uneven surface,
wherein a mean spacing Sm of an unevenness on the uneven surface of the base material is 45 μm or more,
wherein an average tilt angle θa of the unevenness on the uneven surface of the base material is 0.5° to 15°, and
wherein a 60-degree glossiness GL on the uneven surface of the base material is 60% or less.

2. The transparent adhesive film according to claim 1, wherein the transparent adhesive film includes two or more laminate units each including the base material and the adhesive layer.

3. The transparent adhesive film according to claim 1, further comprising:
a release treatment layer formed on the uneven surface of the base material.

4. The transparent adhesive film according to claim 1,
wherein the adhesive layer positioned at an outermost side of the transparent adhesive film has a storage elastic modulus of 1×10⁶ Pa or less at 23° C., the storage elastic modulus being measured by dynamic viscoelasticity measurement under a condition of a shear strain at a frequency of 1 Hz.

5. The transparent adhesive film according to claim 1,
wherein the adhesive layer contains at least one selected from the group consisting of an acrylic adhesive and a rubber adhesive.
